(19) United States
(12) Patent Application Publication
(10) Pub. No.: US 2005/0284541 A1
(43) Pub. Date: Dec. 29, 2005

(54) Log splitter

(75) Inventors: Thomas Michael Walker, Streator, IL (US); Christopher Gerard Walker, Streator, IL (US)

Correspondence Address: BARNES & THORNBURG, LLP, P.O. BOX 2786, CHICAGO, IL, 60690-2786, US

(73) Assignee: Brave Products, Inc.

(21) Appl. No.: 11/024,154

(22) Filed: Dec. 23, 2004

Related U.S. Application Data
(63) Continuation-in-part of application No. 10/876,326, filed on Jun. 24, 2004.

(51) Int. Cl. B27L 7/00

(52) U.S. Cl. 144/193.2; 144/195.8

(57) ABSTRACT

A log splitter which includes an elongated frame which defines a reservoir for hydraulic fluid. A log splitting wedge secured to one end of the frame and a hydraulic cylinder and ram/piston secured to the other end of the frame. The ram/piston being movable toward and away from the wedge. The reservoir includes an inlet and outlet and a discharge tube associated with the inlet having a length effective to discharge incoming fluid into the reservoir at a position remote from the inlet. The elongated tube may be associated with the reservoir outlet so as to draw fluid from the reservoir and thus maximize flow from the reservoir even if the reservoir, or log splitter is in a tipped position. A log splitter and arm for mounting the splitter to a vehicle having a hitch style receiver secured to the rear of the vehicle. The splitter has a substantially linear working action. The mounting system includes an elongated arm for securement to the receiver in a cantilever fashion. The splitter is adapted to be secured, by a pin or a set screw mechanism, to the arm and be supported above the ground. The splitter's linear working action is substantially normal to the vehicle's direction of movement and the support arm. This system permits the vehicle to travel at normal highway speeds and carry the splitter.

### CROSS REFERENCE TO RELATED APPLICATION

This application is a continuation-in-part of application Ser. No. 10/876,326 filed Jun. 24, 2004.

### FIELD OF THE INVENTION

This invention relates to log splitters and more particularly to a log splitter which is smaller and lighter in weight than available conventional splitters and that can be mounted to and carried on a vehicle on a road or highway.

### BACKGROUND OF THE INVENTION

Wood in the form of logs is frequently used as a fuel in stoves, fireplaces, furnaces and at remote locations such as campsites. The log must be of a size suitable for use. Usually this means that the log is to be cut and split to size. Such sizing can be by a hydraulic log splitter wherein a hydraulic ram drives the log against a wedge which splits or cuts the log.

Frequently the source of wood or logs is in a remote location, such as a forest. Thus, it is necessary to bring the log splitter to the location. In addition, the site where the wood is to be used can be nearby or may be a substantial distance from the site where the wood is to be collected or secured. Thus, it is desirable to transport the log splitter to the collection or use site using a vehicle such as a pick-up truck which can travel on a highway or road at speeds such as 55 miles per hour (mph).

However, it has been found that available log splitters are not suitable for highway use since they are not towable at highway speeds. Moreover, such log splitters present problems when the vehicle is backed up, particularly as it can't be seen due to its short width.

Therefore, it is an object of this invention to provide a log splitter and mounting system for a pick-up truck or similar vehicle, that is to be used on a highway, at highway speeds, which mounting system is compatible with such use.

Furthermore, it is desirable to provide a splitter than can be used for residential projects, can be stored in a residential garage, can be moved by hand, can be used at a camp site and can be easily shipped. Conventional and available splitters are too large and too heavy for such uses and/or shipment.

Thus, it is another object of this invention to provide a splitter which fulfills such residential or local uses and can easily be shipped.

In addition, the splitter includes a hydraulic valve, cylinder and pump which are operatively associated with a hydraulic reservoir and operated to urge wood against a wedge for splitting.

When the splitter is not level, or in a tipped position, the hydraulic fluid may not flow properly between the reservoir, valve, pump and cylinder.

It is yet another object of this invention to provide a log splitter which is constructed to enhance proper hydraulic fluid flow even when the splitter is tipped.

These and other objects of this invention will become apparent from the following description and appended claims.

### SUMMARY OF THE INVENTION

There is provided a splitter which is smaller and lighter in weight than conventional splitters so as to meet the uses described above. The splitter includes an elongated frame, a wedge at one end of the frame and a hydraulic cylinder and piston/ram at the other end of the frame. The piston/ram is movable toward and away from the wedge. A hydraulic fluid reservoir with an inlet and an outlet is provided in association with the frame and includes an elongated tube within the reservoir for maximizing the mixing of hydraulic fluid entering the reservoir with fluid therein and minimizes the direct flow of fluid between the inlet to the outlet. The log splitter of this invention is constructed so as to enhance proper hydraulic fluid flow between the reservoir and cylinder even when the splitter is not level or in a tipped position.

The elongated tube within the reservoir is connected or operatively associated at one end with one of the inlet or outlet and enhances the mixing of incoming hydraulic fluid with fluid in the reservoir. The other, or free end of the tube is remote from the other of the inlet or outlet so as to minimize direct flow of fluid between the inlet and outlet.

Frequently, the inlet and outlet are positioned vertically with one above the other and the outlet being in the lower position. When the tube is associated with the outlet, flow of fluid from the reservoir to the cylinder is enhanced even if the splitter is in the tipped position. In other words the tube is positioned in the reservoir such that when one end is associated with the outlet in a lower position, the other end of the tube is immersed in fluid for delivery from the reservoir.

In addition, there is provided by this invention a log splitter and mounting system which permits the mounting of the splitter on the back of a pick-up truck or the like, spacing of the splitter above the road surface on which the vehicle operates, and the use of the truck or other vehicle at normal highway speeds. The mounting system includes an elongated and stepped support arm that is secured at one end to a hitch mounting or receiver on the rear of the truck. The arm is connected to and extends rearwardly from the hitch in a cantilevered manner. Due to the stepped construction, the arm can be rotated to adjust the splitter's clearance from the highway.

The splitter is mounted to the support arm at an orientation transverse to the arm and generally parallel to the back of the truck. Thus, the working action (i.e., movement of the piston/ram) of the splitter, is substantially linear, transverse to the support arm and transverse to the normal direction of movement of the vehicle.

The length of the splitter is equal to the width of the truck, so as to avoid the splitter overhanging the truck sides and extending beyond the truck width into the road.

With this system, the splitter is smaller and of a lighter weight than conventional splitters and with the mounting system, can be mounted to a truck, spaced above the road surface and the truck can travel, with the splitter, at acceptable highway speeds.

### BRIEF DESCRIPTION OF THE DRAWINGS

FIG. 1 is a perspective style view of a log splitter on a securement arm taken from the back of the truck at the hydraulic cylinder end of the splitter;

FIG. 2 is similar to FIG. 1 except taken from the other side and showing the hitch and securement/mounting arm;

FIG. 3 is a view similar to FIG. 2 showing the truck tailgate in a lowered position, logs on the ground, a log being split and split logs on the truck bed;

FIG. 4 is a plan view looking downwardly and showing a log on the splitter being split;

FIG. 5 is a view showing the splitter and support arm positioned for mounting in the truck's hitch or receiver;

FIG. 6 is an enlarged view showing one end of the mounting arm in the hitch receiver and being secured thereto by a pin;

FIG. 7 is a side view showing the back of a truck with the truck's tailgate raised, the securement arm in an upper position, and the splitter carried by the arm and positioned near the rear of the truck;

FIG. 8 is similar to FIG. 7 with the truck tailgate lowered and the splitter moved rearwardly on the support arm;

FIG. 9 is a perspective style view taken from the bottom of the splitter showing the support arm and a support bracket, the manner in which the splitter attaches to the arm and a base for splitter components such as the motor and hydraulic pump; and

FIG. 10 is a diagrammatic style view showing the operation of the hydraulic ram and a guide system for the ram.

FIG. 11 is a vertical sectional view taken along line 11-11 of FIG. 1 showing the reservoir and an elongated inlet tube associated with the inlet;

FIG. 12 is an end view showing the reservoir, wedge, support plate and wheels for the splitter of this invention.

FIG. 13 is a view similar to FIG. 9 showing a set screw mechanism for securement of the splitter and support arm;

FIG. 14 is a sectional view taken along lines 14-14 of FIG. 13;

FIG. 15A is a vertical sectional view similar to FIG. 11 with the elongated tube associated with the reservoir outlet and in a lower position;

FIG. 15B is a vertical sectional view similar to FIG. 15A but with the reservoir tipped in a downhill or counter-clockwise manner; and

FIG. 15C is a vertical sectional view similar to FIG. 15A but with the reservoir tipped in an uphill or clock-wise manner.

FIG. 16 is a perspective style view taken from the back of the log-splitter and showing various hydraulic connections; and

FIG. 17 is a schematic-like drawing showing the hydraulic circuit used in this invention.

### DESCRIPTION OF THE PREFERRED EMBODIMENT

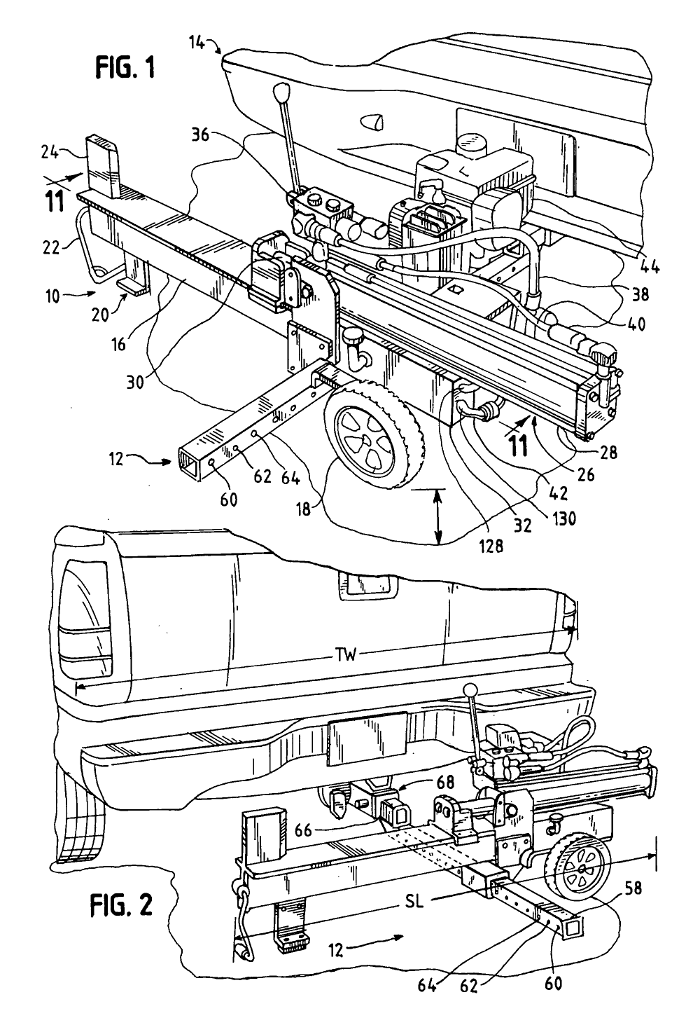

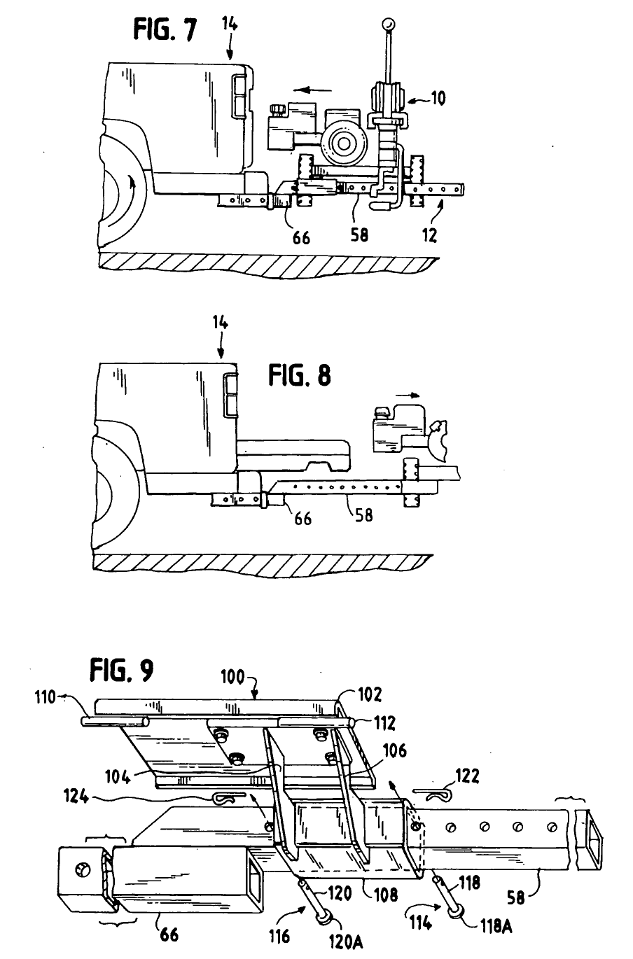

Referring now to the drawings and figures such as FIGS. 1 and 7, there is seen a log splitter 10 generally that is mounted to and carried by a support arm 12 generally which is mounted to the back of a vehicle 14 generally and above the road surface.

The splitter 10 generally includes an elongated frame 16 which includes a pair of wheels, such as 18, mounted to the underside and at one end of the frame. An arm or stop bracket 20 is also on the underside of the frame at the other end. A lifting handle 22 is secured to the frame adjacent the arm or stop bracket 20 so as to permit the splitter to be lifted and rolled to a destination, like the mounting position or a position for use off the support arm.

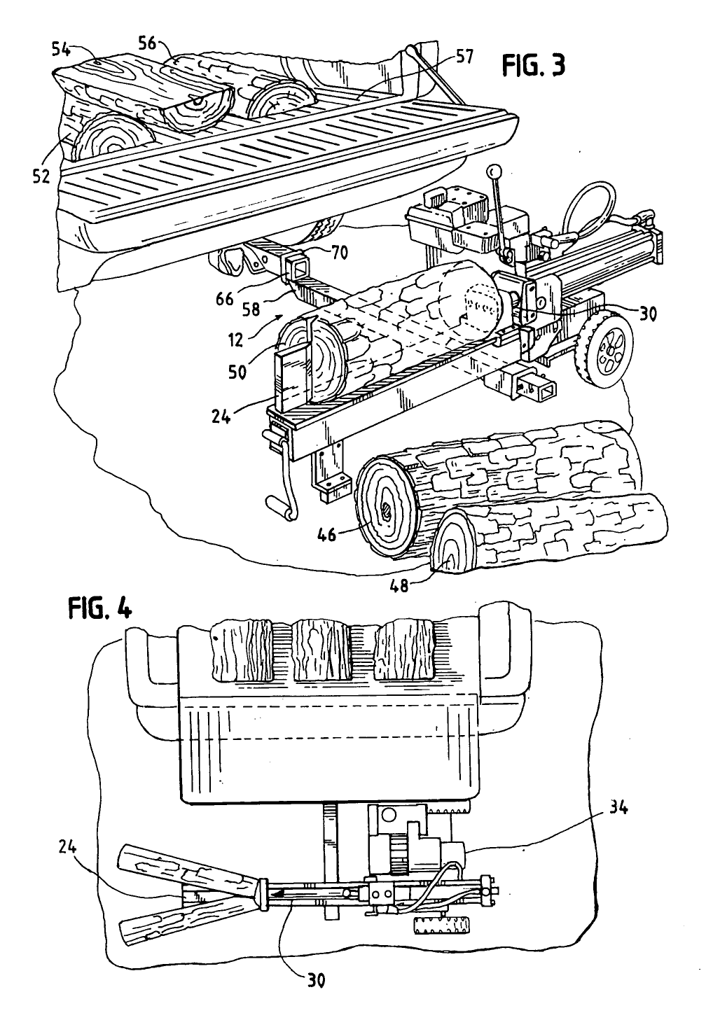

A log splitting wedge 24 is mounted to the top side of the frame at one end and generally above the stop bracket. A hydraulic cylinder assembly 26 is mounted at the other end of the frame above the wheels, such as 18. The cylinder assembly includes a cylinder 28, a piston ram 30 (best seen in FIGS. 3, 4 and 10), a hydraulic reservoir 32, a hydraulic pump 34 (seen in FIG. 4), a hydraulic valve and control 36 and hydraulic lines 38, 40 and 42. The reservoir 32 extends the length of, and acts as the frame 16. A small internal combustion engine 44 is provided to drive the pump. In operation, the engine 44 powers the pump through which the valve 36 permits the hydraulic fluid to move via lines 38, 40 and 42 between the reservoir 32 and the cylinder 28. This flow of hydraulic fluid causes the piston ram 30 to advance from the cylinder 28 toward the wedge 24 or retract from the wedge into the cylinder.

Referring now to FIGS. 3 and 4, logs such as 46, 48 and 50 are positioned on the splitter between the ram and wedge. The log is split by the piston ram 30 engaging the log 50 and urging it against the wedge 24.

The split log segments such as 52, 54 and 56 are then loaded on to the truck bed 57.

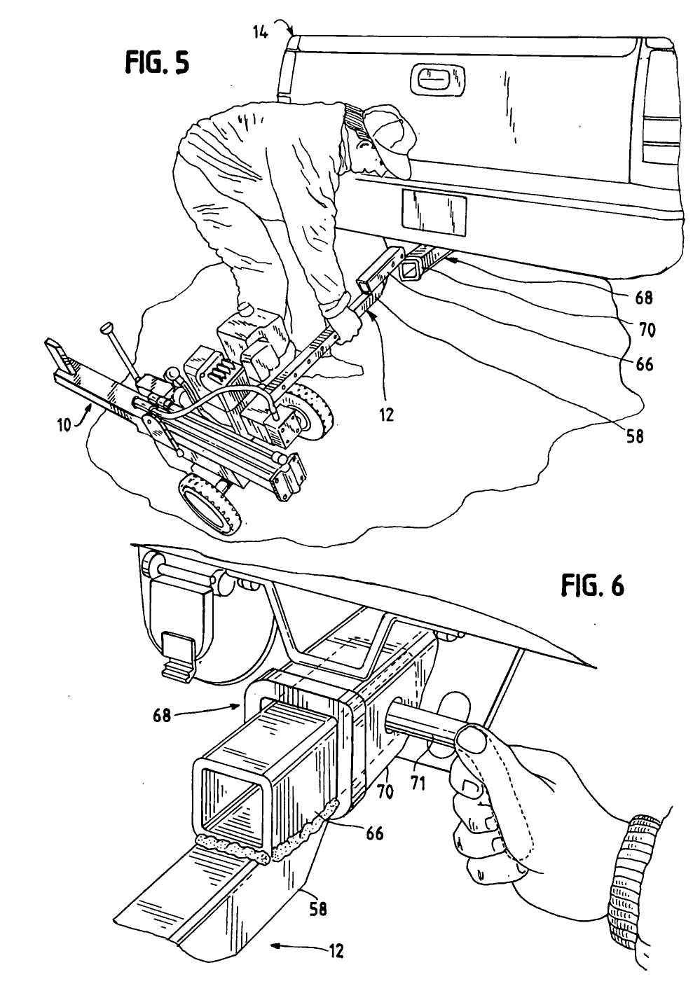

The support arm 12 includes a long splitter-carrying segment 58 that includes a plurality of longitudinally arranged apertures such as 60, 62 and 64. The segment 58 is a hollow square-shaped member. A short hitch engaging segment 66 is welded to the long segment 58 at the end of the arm 12. This is seen in FIGS. 5 and 6. Except for the length, the short segment 66 is akin to the long segment 58 and is a hollow square shape.

The truck 14 is provided with a hitch receiver assembly 68 that includes a hollow square shaped tubular member 70 secured to the truck frame.

Referring to FIG. 6, the short segment 66 is inserted into the square shaped tubular member 70 until the long segment 58 engages an edge of the hitch. Then a locking pin 71 is inserted through the hitch and segment 66 to secure the support arm 12 in a locked and cantilevered position above the road surface. It will be appreciated that the arm can be rotated 180° about its length so that the long segment's clearance relative to the road can be adjusted. See FIGS. 6 and 7.

Referring now to FIG. 5, it is seen that the log splitter 10 is rolled into position behind the truck 14 and the securement arm 12 is lifted into position relative to the hitch. The splitter is then lifted and pushed toward the truck and the support arm 12, specifically segment 66 is slid into the tubular member 70 and secured thereto by pin 71.

The log splitter 10 includes on its underside, a bracket-like assembly 100 which supports the motors and pumps. The bracket 100 includes a base plate 102, a pair of support members 104 and 106 and a tubular slide member 108. Each of the support members 104 and 106 are secured to the base and slide member 108. The slide member 108 is a tubular member having a square cross-section which fits in a telescoping manner about the long segment 58 of the support arm 12.

The base 102 includes axles 110 and 112 for wheels such as 18. As indicated above, the internal combustion engine 44, the hydraulic cylinder 28 and the hydraulic pump 34 and other splitter parts are mounted to or carried by the base.

Thus, by sliding the member 108 on the segment 58, the splitter 10 is moved along the length of the arm 12 and toward or away from the pick-up truck 14. The slide member 108 is fixed in position on the segment 58 by the use of pin assemblies such as 114 and 116. Each assembly includes a headed pin member 118 or 120 and a cotter pin 122 or 124. Each pin member 118 and 120 is constructed to pass through an aperture such as 60, 62 and 64 in the segment 58. The pins are positioned on either end of the slide member 108 so as to keep the member 108 and the splitter 10 in position on the segment. The pins are held in the segment holes by the cooperation of the cotter pins 122 and 124 and the pin heads 118a and 120a. It will be appreciated that this securement mechanism can be used when the splitter is moved toward or away from the truck.

Usually, the splitter 10 is moved toward the truck, as seen in FIG. 7, when the splitter is to be transported and away from the truck when the truck reaches its destination where the splitter is used. There the pins 118 and 120 are removed and the splitter is moved to a rearward position on the support arm 12 as seen in FIG. 8. At this position, the splitter can be resecured in position on the arm by the pins 118, 120 or removed from the arm for use on the ground.

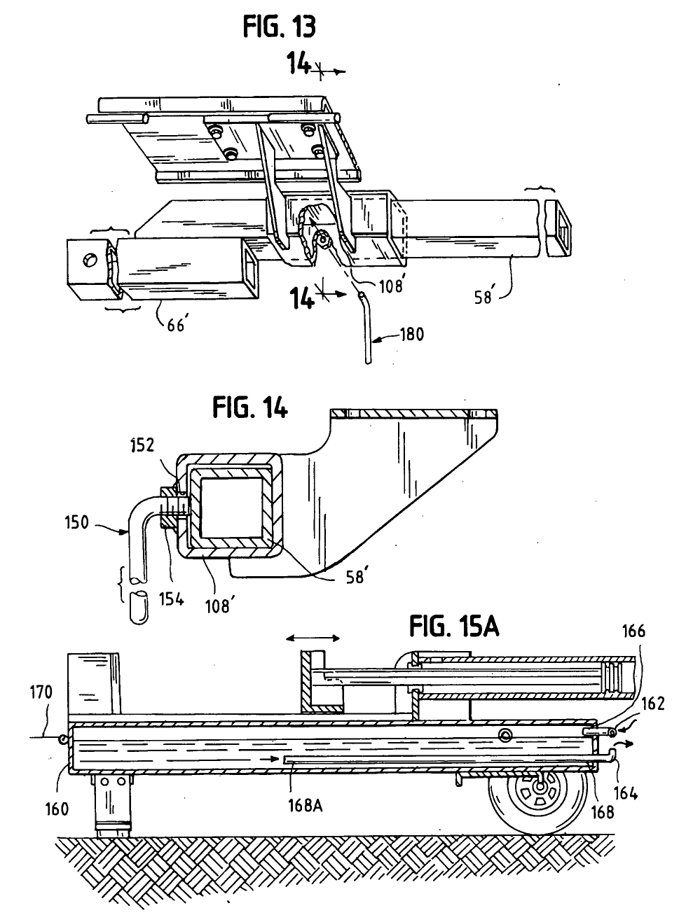

As an alternative, a set screw arrangement 150 as seen in FIGS. 13 and 14 can be provided to secure the splitter 10 generally to the arm 12. The bracket system in FIG. 13 is similar to that shown in FIG. 9. The components are fundamentally common. However, where specific components are referred to, a prime designation (′) after the reference numeral is used. More specifically, an aperture 152′ is provided in the side of the slide member 108′. A threaded weld nut 154′ is welded to the slot 108′ about the aperture 152′. A threaded and L-shaped set screw (similar to an Allen wrench) threadably engages the weld nut 154′, extends through the aperture 152′ and abuts or engages the long segment 58′. Further inward rotation of the set screw pushes the inner or long segment 58′ against the slide member 108′ and effectively locks the splitter 10 to the arm 12. Reverse rotation or loosening of the set screw releases the locking engagement and permits the member 108′ to slide on the segment 58′.

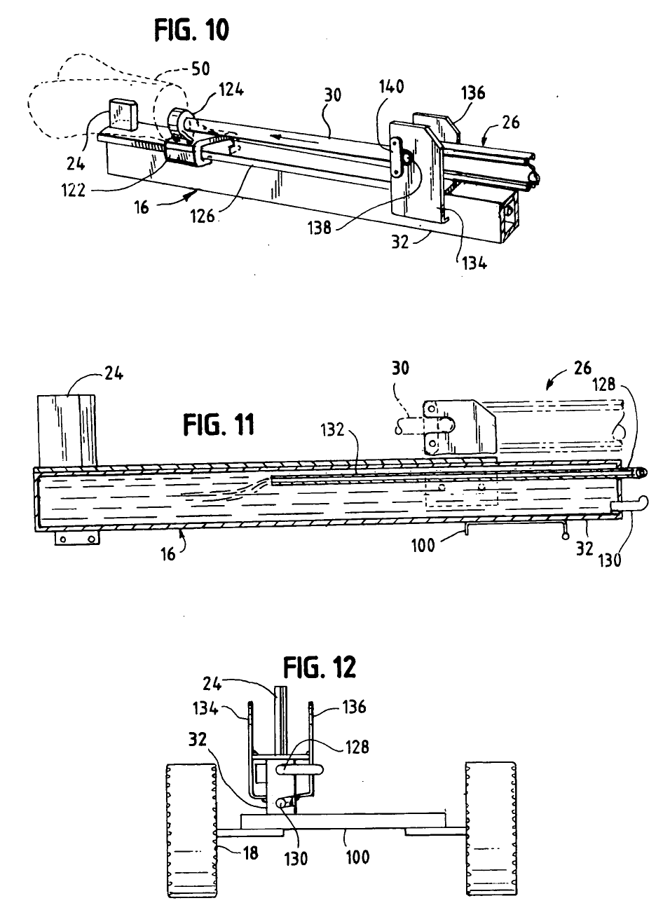

Referring now to FIG. 10, it is seen that the ram 30 is extended and is urging the log 50 into the wedge 24 in order to guide the movement of the ram 30, a somewhat “C” shaped bracket 122 is provided in association with the ram head 124. The bracket 122 grasps the rail 126 on the frame.

Referring now to FIG. 2, the length SL of the splitter is less than or equal to the width (TW) of the pick-up truck. Usually the splitter length (SL) is about equal to the truck width (TW).

As indicated above, the log splitter includes the splitter frame 16, wheels such as 18, the arm or stop bracket 20, the lifting handle 22 and a log splitting wedge 24. With respect to the hydraulics of the system, there is included a hydraulic cylinder assembly 26 which includes the cylinder 28 and piston arm 30, the hydraulic pump 34, the hydraulic valve 36 and the hydraulic lines 38, 40 and 42. The pump 34 driven by the internal combustion engine 44.

Referring now to FIGS. 1 and 11, it is seen that the reservoir 32 forms the frame 16. The reservoir is basically an elongated and rectangularly shaped member which is secured to the bottom bracket or platform 100. The reservoir 32 includes an inlet 128 which receives oil that has been used in the cylinder and which may be hot. An inlet tube is secured to the tank at the inlet and is about ½ the length of the reservoir. Thus, incoming hydraulic fluid is discharged into the reservoir or tank remote from the inlet 128. This permits the hot or used fluid to dilute itself and cool itself within the reservoir. An outlet 130 is provided for the withdrawal of fresh fluid from the reservoir or tank for use. The length of tube 132 is sufficient and effective to discharge the fluid in the tank and prevent the direct flow of discharge fluid to the outlet. In other words, incoming fluid is not short-circuited to the outlet.

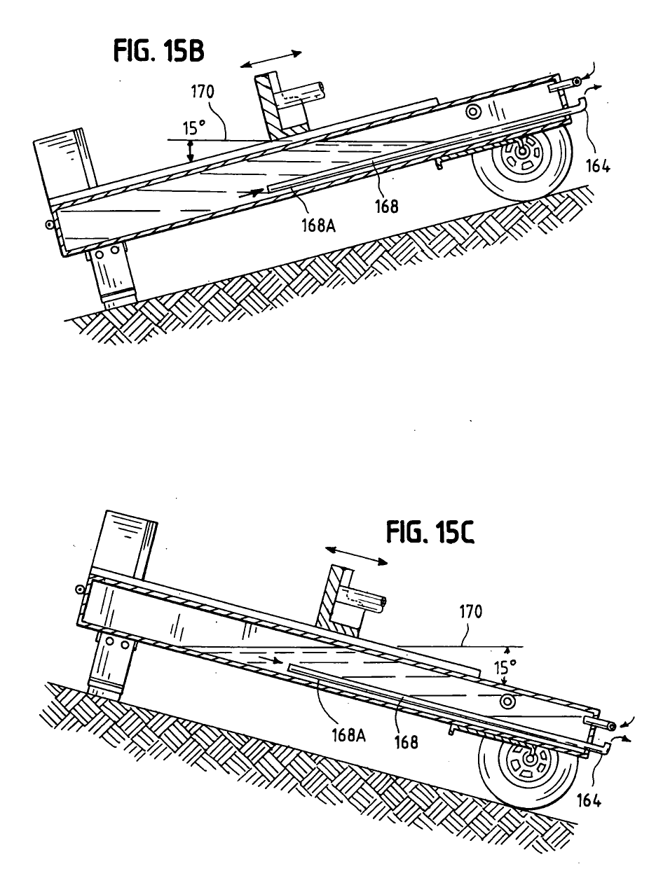

In FIG. 15A the splitter assembly and thus reservoir or tank 160 is shown in an essentially horizontal position. An inlet 162 is provided for the inflow of used hydraulic fluid into the reservoir. An outlet 164 is provided for the outflow of hydraulic fluid from the reservoir. The inlet 162 is positioned above the outlet 164. The inlet 162 includes a short tube 166 which extends into the reservoir and is connected to line 39. The outlet 164 can include the elongated tube 168 which is within the reservoir. The outlet is also connected to line 42 outside the reservoir. It is noted that the reservoir ends of the tubes 166 and 168 are remote from one another so as to assure mixing of incoming fluid with fluid in the reservoir, cooling of hot used fluid entering the reservoir by fluid within the reservoir and minimizes the short circuiting of hot fluid flowing into the reservoir and directly to the outlet 164 of the reservoir. The oil level in the reservoir is indicated by line 170. In FIG. 15A it is seen that incoming fluid flows through the inlet 162 and inlet tube 166 into the reservoir, dilutes into oil already in the reservoir and exits the reservoir through elongated tube 168 and particularly at the free end 168A of the tube. Thus, fluid exiting the reservoir flows through end 168A, through the tube 168 and through the outlet 164.

In the event the reservoir is tipped, due to positioning of the splitter, the reservoir is tipped relative to the oil level indicated by line 170. In FIG. 15B it is seen that the elongated tube 168 and free end 168A are positioned below the oil level and immersed in the oil so as to draw fluid through the end 168A, the tube 168 and the outlet 164. Incoming fluid is not substantially affected.

In the event the splitter is tipped the other direction, the oil line 170 is shown and the inlet tube 168 and end 168A are still immersed in the oil so as to draw fluid through the outlet 164.

It will be appreciated as indicated above that the oil flow is maintained even when the reservoir and splitter are in a tipped position.

In FIG. 12, a pair of cylinder support trunions 134, 136 are welded to the reservoir or frame and the hydraulic assembly 26 is secured thereto by pins such as 138 and a small closure bracket 140.

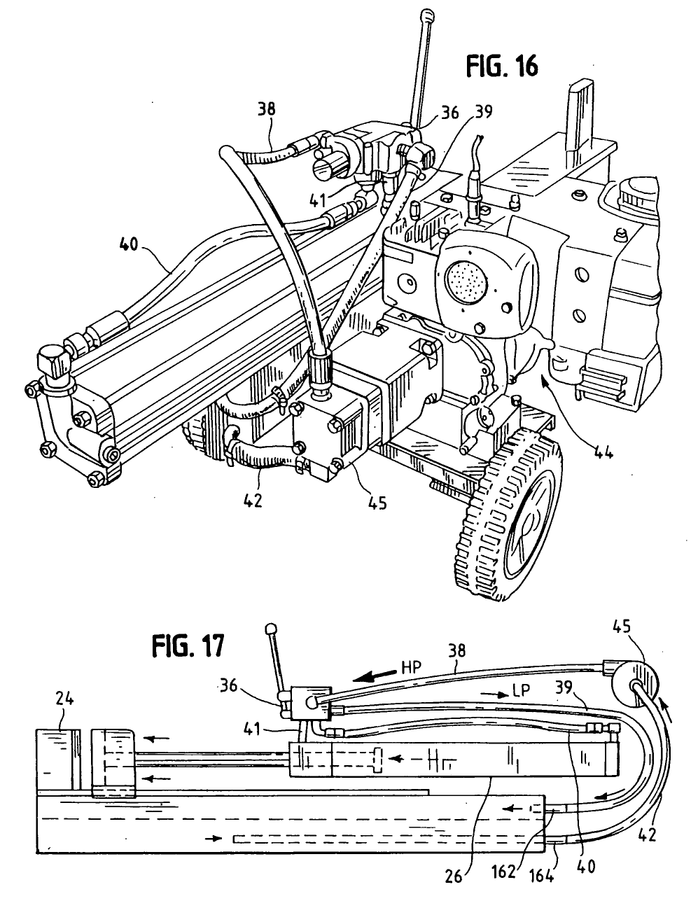

Referring now to FIGS. 16 and 17 and particularly the hydraulic circuit, the internal combustion engine 44 drives the pump 45. Fluid is moved from the pump 45 via line 38 under high pressure to valve 36. Valve 36 is operated so as to deliver high pressure fluid via line 40 to the cylinder 26. The delivery of this fluid causes the ram and piston to extend toward the wedge 24. Used fluid from the piston is urged at low pressure via line 41 back to the valve 36 and from the valve 36 is urged under low pressure via line 39 to the reservoir inlet such as 162. Fluid in the reservoir is drawn through the outlet 164 via line 42 to pump 45.

When the ram is retracted the flow in lines 40 and 41 is reversed and the pressures changed from high or low or vise versa as appropriate.

Numerous changes and modifications can be made to the embodiment disclosed herein without departing from the spirit and scope of this invention.

1. A log splitter and support arm assembly for mounting on a vehicle constructed for use on a road and having a hitch-style receiver secured to the rear of the vehicle for cooperation with the arm in supporting the splitter, spacing the splitter from the road, wherein the splitter assembly includes:
an elongated support arm having one end (a) constructed to be received by the hitch-style receiver and (b) constructed to support the log splitter thereon and (c) constructed to space the log splitter from the road; and
said log splitter (a) being elongated, (b) having a substantially linear working action, and (c) being carried by the support arm substantially normal thereto and substantially normal to the direction of movement of the vehicle on the road.

2. A log splitter and support arm assembly as in claim 1 wherein the support arm extends rearwardly of the vehicle in a cantilevered manner.

3. A log splitter and support arm assembly as in claim 1 wherein the log splitter is mounted on the support arm and movable thereon toward and away from the vehicle.

4. A log splitter and support arm assembly as in claim 3 wherein the log splitter includes a slide member constructed to slidingly mate with the support arm for movement thereon and securement thereto.

5. A log splitter and support arm assembly as in claim 4 wherein the support arm is tubular and has a substantially rectangular cross-section and said mating slide member is tubular and has a substantially rectangular cross-section sized to fit around the support arm and slide thereon.

6. A log splitter and support arm assembly as in claim 5 wherein there is defined by the arm a plurality of positions on the support arm for securement of the mating slide member thereto.

7. A log splitter and support arm assembly as in claim 1 wherein the support arm includes a long segment and a short segment secured to one end of the long segment, which short segment is constructed to be received by hitch-style receiver.

8. A log splitter and support arm assembly as in claim 1 wherein the splitter assembly is elongated in the length of the splitter is less than or equal to the width of the vehicle.

9. A log splitter and support arm assembly as in claim 8 wherein the log splitter includes an elongated frame, a log splitting wedge mounted at one end of the frame and a hydraulic cylinder and piston rod assembly mounted at the other end of the frame, with the piston rod movable toward and away from the wedge and adapts to engage a log to be split and urge the log toward the wedge.

10. A log splitter and support arm assembly as in claim 9 wherein the splitter includes a pair of support wheels, mounted to the frame, adjacent the cylinder and piston rod assembly for rotation generally parallel to the frame and a handle mounted to the frame adjacent the wedge for lifting the frame so as to be supported on the wheels and for moving the splitter on the wheels.

11. A mounting arrangement for a log splitter having a linear working action, to be mounted to a vehicle having a rear hitch-style receiver and constructed for road use whereby the hitch-style receiver supports the splitter and spaces the splitter from the road, said mounting arrangement including:
an elongated support arm (a) constructed to be received by and secured to a hitch-style receiver, (b) constructed to extend radially of the vehicle and be spaced from the road, (c) constructed to support the splitter assembly and an orientation where the linear working action is substantially normal, the support arm and (the) constructed to space the log splitter above the road.

12. A mounting arrangement as in claim 11 wherein the support arm includes an elongated segment and a short segment secured to one end of the arm and adapted to be received in the receiver.

13. A mounting arrangement as in claim 11 wherein said elongated support arm includes a plurality of locking apertures for securing the splitter to the arm.

14. A mounting arrangement as in claim 11 where there is further provided a slide bracket constructed to support said splitter assembly and to engage the support arm, to move the splitter toward and away from the vehicle and for locking securement to said support arm.

15. A mounting arrangement as in claim 12 wherein the short and long segments are secured to each other in a step-like fashion and said arm is constructed to be secured to the hitch in a first lower position and rotated so as to be secured to the hitch in an upper position whereby the clearance between the road and the long segment is adjustable.

16. A log splitter which includes:
an elongated frame member;
a log splitting wedge mounted at one end of the frame;
a hydraulic cylinder and piston/ram assembly mounted to the frame at the other end thereof and constructed for the ram to move between the cylinder and wedge;
a hydraulic pump and hydraulic valve for communication of hydraulic fluid to and from the cylinder;
a motor for operating said pump;
a platform associated with the frame for supporting the pump, valve and motor;
a plurality of wheels rotatably secured to the platform for cooperation in supporting and moving said splitter;
said frame defining a reservoir for hydraulic fluid, said reservoir defining an inlet adapted to receive used fluid, adapted to store fluid entering the reservoir and defining an outlet for the withdrawal of stored fluid from the reservoir, and
an elongated inlet tube positioned within the reservoir and connected to the inlet and having a length effective to discharge fluid entering the inlet within the reservoir at a position remote from the outlet.

17. A log splitter as in claim 16 wherein the length of the tube is effective to maximize the mixing of incoming fluid with stored fluid in the reservoir and minimize direct flow of fluid between the inlet and outlet.

18. A log splitter as in claim 16 wherein the tube extends substantially within the reservoir.

19. A log splitter as in claim 17 wherein the length of the tube is about half the length of the reservoir.

20. A reservoir for hydraulic fluid and for use in a log splitter comprising:
an elongated and hollow reservoir for hydraulic fluid,
an inlet to the reservoir is provided for receiving used hydraulic fluid and arranged to deliver the used fluid into the reservoir;
an outlet from the reservoir is provided from which fluid within the reservoir flows from the reservoir; and
an elongated tube positioned within the reservoir and having one end associated with one of the inlet or outlet and the other end spaced from the other of the inlet and outlet.

21. A reservoir as in claim 20 wherein said elongated and hollow reservoir has a box-like shape.

22. A reservoir as in claim 20 wherein said reservoir includes an end wall and said inlet is positioned in said end wall.

23. A reservoir as in claim 22 wherein said elongated tube is associated with said inlet.

24. A reservoir as in claim 20 wherein said reservoir includes an end wall and said outlet is positioned in said wall.

25. A reservoir as in claim 24 wherein said elongated tube is associated with said outlet.

26. A reservoir as in claim 25 wherein said inlet and said outlet are both in the said end wall and said inlet is positioned above said outlet.

27. A system for mounting a log splitter and carrying said log splitter on a vehicle having a hitch-style receiver that is constructed to receive a support arm on which the splitter is slidably mounted, said system including;
an elongated support arm constructed to be secured to a vehicle receiver and constructed to slidably support and carry a log splitter,
a member associated with said splitter and adapted to slidably engage said arm and slidably move along the arm toward and away from the vehicle, and
a set screw type assembly associated with the slide member and constructed to engage the support arm so as to position the arm relative to the slide member.

28. A system as in claim 27 wherein:
said support arm is a bar-like member,
said slide member includes a hollow tubular member which fits about said support arm and said set screw type assembly includes an aperture in the slide member, a threaded weld nut-type member secured to the slide member about the aperture, and a thread threaded screw-like member which is constructed to threadably engage said weld nut type member and to abut the support member and lock the slide member in position relative to the support member when the screw like member is advanced into the weld nut.

29. A system as in claim 27 wherein said support arm is a hollow tubular member.
